(19) United States
(12) Patent Application Publication
(10) Pub. No.: US 2026/0058397 A1
(43) Pub. Date: Feb. 26, 2026

(54) FINGER-PROOF ELECTRICAL TERMINAL

(71) Applicant: GM GLOBAL TECHNOLOGY OPERATIONS LLC, Detroit, MI (US)

(72) Inventors: Kevin J. Lapprich, Sterling Heights, MI (US); Robert J. Heydel, Clawson, MI (US); William J. Bartlomiej, II, New Haven, MI (US); William T. Kucinski, Windsor (CA); Timothy G. Ross, Washington, MI (US)

(73) Assignee: GM GLOBAL TECHNOLOGY OPERATIONS LLC, Detroit, MI (US)

(21) Appl. No.: 18/813,967

(22) Filed: Aug. 23, 2024

(51) Int. Cl. H01R 13/44; H01R 4/30

(52) U.S. Cl. CPC H01R 13/44; H01R 4/307; H01R 2201/26

(57) ABSTRACT

An electrical terminal includes a first terminal cap, a second terminal cap, a blind-hole nut, a socket, first terminal barrel, and a threaded stud. The first terminal cap is couplable to a first side of a busbar. The second terminal cap is couplable to a second side of the busbar and is connected to the first terminal cap. The blind-hole nut is disposed in the second terminal cap. The socket is couplable to a device and is configured to engage the first terminal cap. The first terminal barrel dispose in the socket and is positioned to electrically engage the busbar. The threaded stud is disposed in the socket and is operational to engage the blind-hole nut. The electrical terminal is finger proof on at least one side of the busbar.

### INTRODUCTION

The present disclosure relates to an assembly and a method for a finger-proof electrical terminal.

Bolted electrical terminal designs integrate low-profile, finger-proofing features to prevent inadvertent contact between electrified terminal surfaces and an operator. The finger-proof electrical terminals allow for simplified battery pack assembly along with improved voltage scalability in a multi-module battery pack. However, assembly of electric vehicles and corresponding battery modules are often done with automation, involving precise placement of modules that are to be connected.

Accordingly, those skilled in the art continue with research and development efforts in the field of finger-proof electrical terminals that allow sliding movement of a distal ends of a busbar relative to the finger-proof terminal connector within an x-y plane.

### SUMMARY

An electrical terminal is provided herein. The electrical terminal includes a first terminal cap, a second terminal cap, a blind-hole nut, a socket, a first terminal barrel, and a threaded stud. The first terminal cap is couplable to a first side of a busbar. The first terminal cap includes a first cap cylindrical wall that defines a first cap cylindrical bore. The second terminal cap is couplable to a second side of the busbar opposite the first side and connected to the first terminal cap. The second terminal cap defines an opening that is sized to be finger proof. The blind-hole nut is disposed in the second terminal cap. The blind-hole nut has a flange and an electrically nonconductive tip opposite the flange. The electrically nonconductive tip and the first cap cylindrical wall are arranged to be finger proof. The socket is couplable to a device. The socket includes a first socket cylindrical wall that defines a first socket cylindrical bore. The first socket cylindrical wall is sized to receive the first cap cylindrical wall. The first terminal barrel is dispose in the first socket cylindrical bore and positioned to electrically engage the busbar. The threaded stud is disposed in the first socket cylindrical bore. The threaded stud is operational to engage the blind-hole nut.

In one or more embodiments, the electrical terminal includes a cap threaded on the second terminal cap and covers the opening.

In one or more embodiments, the electrical terminal includes one or more retaining clips disposed in the second terminal cap. The one or more retaining clips are operational to engage the flange of the blind-hole nut to alternately (i) retain the blind-hole nut proximate the opening and (ii) permit the blind-hole nut to move away from the opening and engage the threaded stud.

In one or more embodiments, the electrical terminal includes an insulator on an exterior of the blind-hole nut, wherein the insulator extends from the electrically nonconductive tip to the flange.

In one or more embodiments, the electrical terminal includes a second terminal barrel (i) disposed between the first terminal barrel and the busbar and (ii) positioned to electrically connect the first terminal barrel to the busbar.

In one or more embodiments, the electrical terminal includes a post disposed coaxially within the threaded stud. The post has a post tip that extends beyond the threaded stud. The post tip and the first socket cylindrical wall are arranged to be finger proof.

In one or more embodiments of the electrical terminal, the second terminal barrel is physically attached to the busbar.

In one or more embodiments of the electrical terminal, the first terminal barrel includes a rim. The first terminal cap defines a recess sized to receive the rim of the first terminal barrel.

In one or more embodiments, the electrical terminal includes a second socket cylindrical wall coaxially disposed inside the first socket cylindrical wall, wherein the first terminal barrel is partially disposed between the first socket cylindrical wall and the second socket cylindrical wall.

In one or more embodiments, the electrical terminal includes a post disposed coaxially within the threaded stud, wherein (i) the post has a post tip that extends beyond the threaded stud and (ii) the post tip, the first socket cylindrical wall and the second socket cylindrical wall are arranged to be finger proof.

A method for manufacturing an electrical terminal is provided herein. The method includes fabricating a first terminal cap couplable to a first side of a busbar. The first terminal cap includes a first cap cylindrical wall that defines a first cap cylindrical bore. The method includes fabricating a second terminal cap couplable to a second side of the busbar opposite the first side. The second terminal cap defines an opening that is sized to be finger proof. The method further includes connecting the first terminal cap to the second terminal cap, and disposing a blind-hole nut in the second terminal cap. The blind-hole nut has a flange and an electrically nonconductive tip opposite the flange. The electrically nonconductive tip and the first cap cylindrical wall are arranged to be finger proof. The method includes fabricating a socket couplable to a device. The socket includes a first socket cylindrical wall that defines a first socket cylindrical bore. The first socket cylindrical wall is sized to receive the first cap cylindrical wall. The method also includes disposing a first terminal barrel in the first socket cylindrical bore and positioned to electrically engage the busbar, and disposing a threaded stud in the first socket cylindrical bore, wherein the threaded stud is operational to engage the blind-hole nut.

In one or more embodiments, the method includes threading a cap on the second terminal cap to cover the opening.

In one or more embodiments, the method includes forming one or more retaining clips in the second terminal cap, wherein the one or more retaining clips are operational to engage the flange of the blind-hole nut to alternately (i) retain the blind-hole nut proximate the opening and (ii) permit the blind-hole nut to move away from the opening and engage the threaded stud.

In one or more embodiments, the method includes forming an insulator on an exterior of the blind-hole nut, wherein the insulator extends from the electrically nonconductive tip to the flange.

In one or more embodiments, the method includes forming a second terminal barrel (i) between the first terminal barrel and the busbar and (ii) positioned to electrically connect the first terminal barrel to the busbar.

In one or more embodiments, the method includes forming a post coaxially within the threaded stud. The post has a post tip that extends beyond the threaded stud. The post tip and the first socket cylindrical wall are arranged to be finger proof.

In one or more embodiments, the method includes attaching the second terminal barrel physically to the busbar.

In one or more embodiments of the method, the first terminal barrel includes a rim, and the first terminal cap defines a recess sized to receive the rim of the first terminal barrel.

In one or more embodiments, the method includes forming a second socket cylindrical wall coaxially inside the first socket cylindrical wall, wherein the first terminal barrel is partially disposed between the first socket cylindrical wall and the second socket cylindrical wall, and forming a post coaxially within the threaded stud. The post has a post tip that extends beyond the threaded stud. The post tip, the first socket cylindrical wall and the second socket cylindrical wall are arranged to be finger proof.

A vehicle is provided herein. The vehicle includes a device, a busbar, a first terminal cap, a second terminal cap, a blind-hole nut, a socket, a first terminal barrel, and a threaded stud. The first terminal cap is coupled to a first side of the busbar. The first terminal cap includes a first cap cylindrical wall that defines a first cap cylindrical bore. The second terminal cap is coupled to a second side of the busbar opposite the first side and is connected to the first terminal cap. The second terminal cap defines an opening that is sized to be finger proof. The blind-hole nut is disposed in the second terminal cap. The blind-hole nut has a flange and an electrically nonconductive tip opposite the flange. The electrically nonconductive tip and the first cap cylindrical wall are arranged to be finger proof. The socket is coupled to the device. The socket includes a first socket cylindrical wall that defines a first socket cylindrical bore. The first socket cylindrical wall is sized to receive the first cap cylindrical wall. The first terminal barrel is dispose in the first socket cylindrical bore and positioned to electrically engage the busbar. The threaded stud is disposed in the first socket cylindrical bore, wherein the threaded stud is operational to engage the blind-hole nut.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a context of a system in accordance with one or more exemplary embodiments.

FIG. 2 is a schematic perspective diagram of a busbar assembly in accordance with one or more exemplary embodiments.

FIG. 3 is a schematic exploded cross-sectional diagram of a terminal connector and a busbar assembly in accordance with one or more exemplary embodiments.

FIG. 4 is a schematic cross-sectional diagram of the terminal connector and the busbar assembly of FIG. 3.

FIG. 5 is a schematic exploded cross-sectional diagram of another terminal connector and the busbar assembly in accordance with one or more exemplary embodiments.

FIG. 6 is a schematic cross-sectional diagram of the terminal connector and the busbar assembly of FIG. 5.

FIG. 7 is a schematic exploded cross-sectional diagram of still another terminal connector and the busbar assembly in accordance with one or more exemplary embodiments.

FIG. 8 is a schematic cross-sectional diagram of the terminal connector and the busbar assembly of FIG. 7.

### DETAILED DESCRIPTION

Embodiments of the disclosure provide a fully finger-proof system in an installed condition and, in some configurations, an uninstalled condition. The system generally incorporates busbar automation, terminal caps, large variation compensating slide, fastener alignment, a captured terminal barrel, and an internal over molded bolt (or threaded stud). One or both mating terminals may be fully finger proof. A blind-hole nut with an electrically nonconductive finger-proof tip protects direct access to high-voltage internal threads of the nut. A cylinder on a device-side terminal cap protects direct access to the high voltage when used in conjunction with a threaded cap over the blind-hole nut. A cylinder on the mating terminal surrounding the threaded stud and protects against direct access to the high voltage via the threaded stud until electrical contact is broken with the conductive material of the blind-hole nut. In various embodiments, the threaded stud is hollow with an internally over molded plastic tip (M-point and/or N-point compliant) into the mating terminal and adding a captured terminal barrel to the busbar. “Finger proof” may be defined by an Ingress Protection (IP) rating defined by the International Electrotechnical Commission (IEC) in international standard IEC-60529. In various situations, the ingress protection rating for a finger-proof sized/arranged/spaced clearance may be approximately 3 millimeters to approximately 8 millimeters.

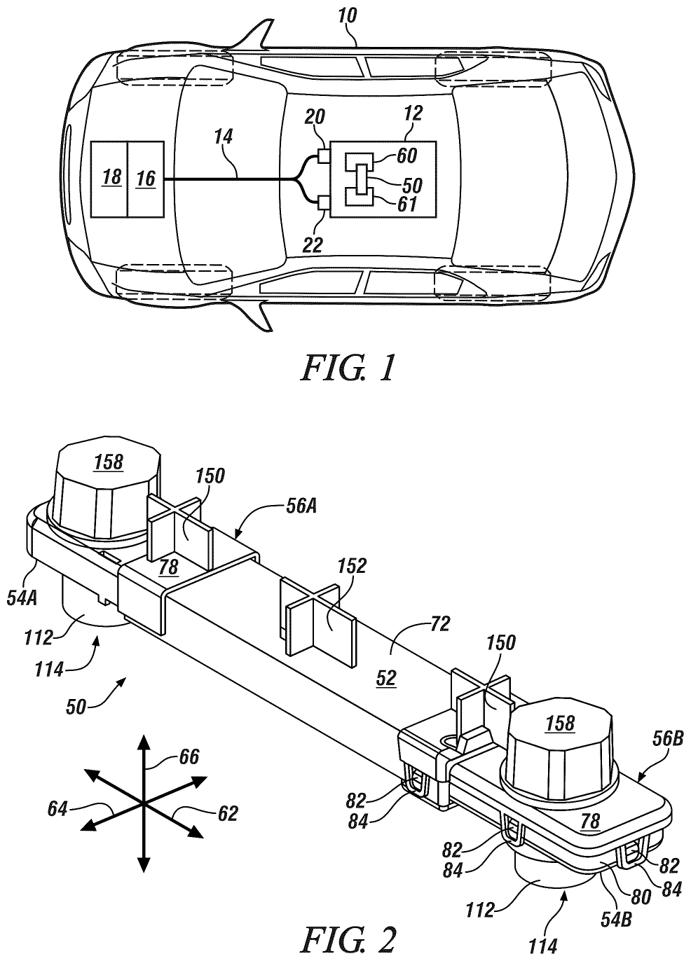

Referring to FIG. 1, a schematic diagram illustrating a context of a system is shown in accordance with one or more exemplary embodiments. The system may implement a vehicle 10. The vehicle 10 generally comprises a battery pack 12, a harness 14, a controller 16, and a motor 18. The battery pack 12 may include a positive battery pack terminal 20, a negative battery pack terminal 22, multiple busbar assemblies 50 (one shown), and multiple devices 60 (one shown).

The vehicle 10 may include, but is not limited to, mobile objects such as a passenger vehicle, a truck, an autonomous vehicle, a gas-powered vehicle, an electric-powered vehicle, a hybrid vehicle, a motorcycle, a boat, a farm vehicle, a train and/or an aircraft. In some embodiments, the vehicle 10 may include stationary objects such as billboards, kiosks and/or marquees. Other types of vehicles 10 may be implemented to meet the design criteria of a particular application.

The battery pack 12 may implement a high-voltage battery pack configured to store electrical energy. The battery pack 12 is generally operational to receive electrical power from the controller 16 and provide electrical power to the controller 16. The battery pack 12 may include multiple battery modules 61 electrically connected in series and/or in parallel between the positive battery pack terminal 20 and the negative battery pack terminal 22. In various embodiments, the battery pack 12 may provide approximately 400 to 800 volts DC (direct current) electrical potential between the positive battery pack terminal 20 and the negative battery pack terminal 22. Other battery voltages may be implemented to meet the design criteria of a particular application. The positive battery pack terminal 20 and the negative battery pack terminal 22 may be physically and electrically connected to the harness 14.

Battery modules 61 made up of stacked battery cells may be connected in series or parallel through use of an electrical interconnect board (ICB), or the battery modules 61 may be connected directly to one another. Individual battery modules 61 and/or the devices 60 are electrically connected together via a busbar assembly 50 configured to connect one battery module to another battery module, to connect a battery module 61 to an electrical interconnect board, and/or to connect a battery module 61 to a device 60.

The harness 14 may implement an electrical harness. The harness 14 is generally operational to carry electrical power between the controller 16 and the battery pack 12. In a charging mode, the harness 14 may transfer the electrical power from the controller 16 to the battery pack 12. In a discharging mode, the electrical power may flow along the harness 14 from the battery pack 12 to the controller 16.

The controller 16 may implement a battery controller. The controller 16 is generally operational to transfer electrical power to the battery pack 12 in the charging mode to charge the battery pack 12. The controller 16 may draw electrical power from the battery pack 12 in the discharge mode. The electrical power received from the battery pack 12 may be used to power the motor 18 and/or other loads within the vehicle 10.

The motor 18 may implement an electric motor. The motor 18 is generally operational to provide rotation and torque to drive wheels of the vehicle 10. The electrical power consumed by the motor 18 may be provided by the battery pack 12 and/or an alternator of the vehicle 10 under the control of the controller 16.

The busbar assemblies 50 are operational to provide electrical power at high voltages between the battery modules 61 and/or devices 60. In various embodiments, each busbar assembly 50 may include a first finger-proof terminal connector at a first distal end of the busbar and a second finger-proof terminal connector at a second distal end of the busbar. In other embodiments, the busbar assembly 50 includes solely the first terminal connector positioned on the first distal end of the busbar and the second distal end of the busbar includes different connection features for connecting the busbar assembly 50 to other electrical components within an electrical system of the vehicle 10. The first terminal connector and the second terminal connector may be identical terminal connectors, and a difference between them is that the first terminal connector is positioned on the first distal end of the busbar and the second terminal connector is positioned on the second distal end of the busbar.

The devices 60 may implement a variety of electrical components that utilize the high voltage available through the busbar assembly 50. The devices 60 may include, but are not limited to motors, power converters, heaters, pumps, and one or more of the battery modules 61.

Referring to FIG. 2, a schematic perspective diagram of an example implementation of a busbar assembly 50 is shown in accordance with one or more exemplary embodiments. The busbar assembly 50 generally includes a busbar 52 having a first distal end 54A and a second distal end 54B. The busbar assembly 50 also includes a first terminal connector 56A positioned on the first distal end 54A of the busbar 52 and a second terminal connector 56B positioned on the second distal end 54B of the busbar 52. Each of the first and second terminal connectors 56A, 56B is configured to electrically connect the busbar 52 to an external terminal. The external terminal may be a terminal of a battery module 61 or other device 60, or a terminal of an electrical interconnect board. Thus, the busbar assembly 50 may be used to interconnect two battery modules 61 together in series, or to connect a battery module 61 to an electrical interconnect board.

In an exemplary embodiment, where the first terminal connector 56A is not connected to an external terminal, the first terminal connecter 56A is adapted to allow limited movement of the first distal end 54A of the busbar 52 relative to the first terminal connector 56A within an x-y plane defined by an x-axis 62 and a y-axis 64, and where the second terminal connector 56B is not connected to an external terminal, the second terminal connecter 56B is adapted to allow limited movement of the second distal end 54B of the busbar 52 relative to the second terminal connector 56B within the x-y plane defined by the x-axis 62 and the y-axis 64. A z-axis 66 may be defined as normal to the x-axis 62 and the y-axis 64.

Each terminal connector 56A, 56B generally includes a first (or lower) terminal cap 80 and a second (or upper) terminal cap 78. The second terminal cap 78 and the first terminal cap 80 including features 82, 84 adapted to secure the second terminal cap 78 to the first terminal cap 80 with the first or second distal end 54A, 54B of the busbar 52 encapsulated therebetween.

A protective outer coating 72 extends along a length of the busbar 52. The first distal end 54A of the busbar 52, including a first slot and the second slot, extends beyond the protective outer coating 72, wherein the first terminal connector 56A encapsules the first distal end 54A of the busbar 52, including the first slot and the second slot, and extends over a first edge of the protective outer coating 72. The second distal end 54B of the busbar 52, including a third slot and a fourth slot, extends beyond the protective outer coating 72, wherein the second terminal connector 56B encapsules the second distal end 54B of the busbar 52, including the third slot and the fourth slot, and extends over a second edge of the protective outer coating 72.

The first (lower) terminal cap 80 of each of the first and second terminal connectors 56A, 56B includes a first cap cylindrical wall 112 that defines a first cap cylindrical bore 114. The first cap cylindrical bore 114 is coaxially aligned with slots within the busbar 52, the blind-hole nut, and the first terminal cap 80.

Each of the first and second terminal connectors 56A, 56B includes a first pick and place feature 150 configured to allow grasping of the busbar assembly 50 by an automated tool. Thus, where the busbar assembly 50 is being supported by the automated tool grasping the first pick and place feature 150 of the second terminal cap 78, the busbar 52 is moveable relative to the terminal connector 56A, 56B within the x-y plane. Thus, the busbar assembly 50 provides for robust assembly processes that may accommodate positional imprecision and dimensional tolerancing between adjacent battery modules 61 and making it possible for an automated (robotic) tool to assemble the busbar assembly 50 to adjacent modules.

In various embodiments, the outer protective coating 72 of the busbar 52 includes a second pick and place feature 152 configured to allow grasping of the busbar assembly 50 by the automated tool. Thus, where the busbar assembly 50 is being supported by the automated tool grasping the second pick and place feature 152 of the outer protective coating 72 of the busbar 52, the first terminal connector 56A is moveable relative to the busbar 52 within the x-y plane and the second terminal connector 56B is moveable relative to the busbar 52 within the x-y plane.

The second terminal caps 78 of each of the first terminal connector 56A and the second terminal connector 56B includes external threads configured to engage internal threads of a cap 158. The cap 158 is flameproof (or flame resistant or fire resistant). The cap 158 generally has a hexagonal shape configured to allow engagement with tooling, either manually or by automation, to selectively assemble or remove the cap 158 from the terminal caps 78, 80. The cap 158 is configured to removably cover an opening within the second terminal cap 78 that is configured to allow access to the blind-hole nut. Thus, once the second terminal cap 78 and the first terminal cap 80 are snapped together, encapsulating the distal end 54A, 54B of the busbar 52 therein, and the terminal connector 56A, 56B is placed onto an external terminal and the blind-hole nut is threaded into a threaded stud the cap 158 is placed onto the second terminal cap 78 to cover the opening therein.

The protective outer coating 72 of the busbar 52, the second terminal cap 78, the first terminal cap 80 and the cap 158 are made from a non-conductive material such that when the busbar assembly 50 is placed onto adjacent modules to conduct electrical current therebetween, the busbar assembly 50 prevents inadvertent contact with electrified surfaces by people or foreign objects.

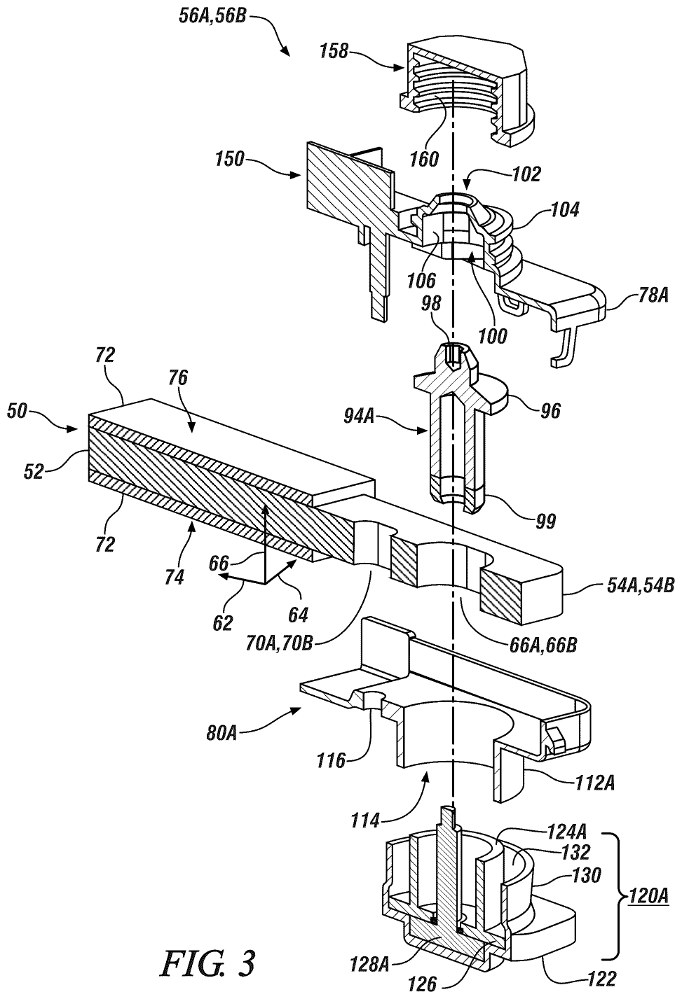

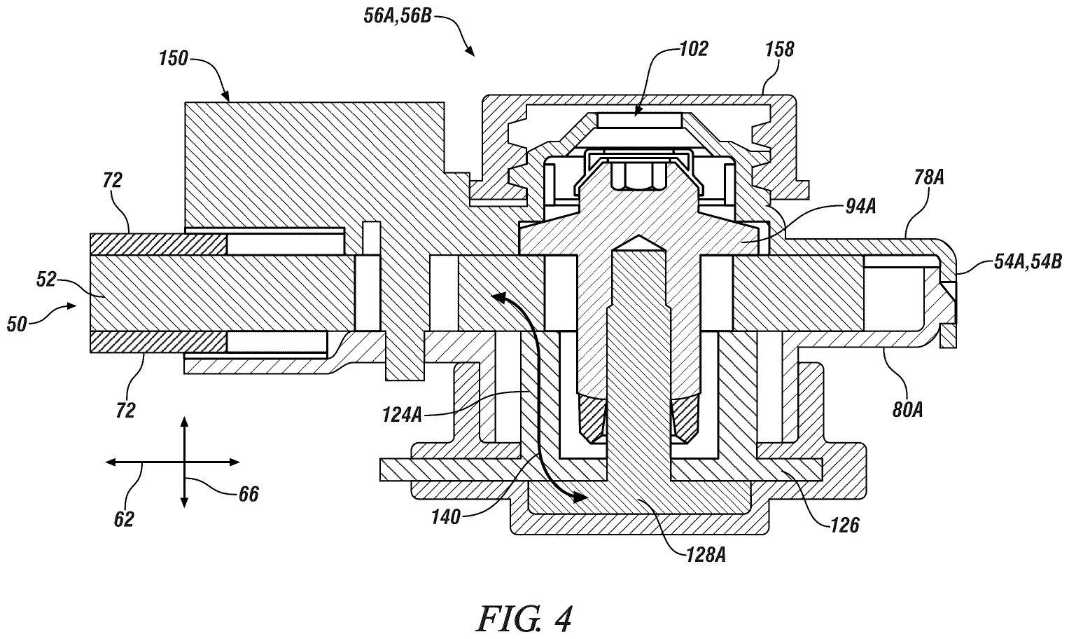

Referring to FIG. 3, a schematic exploded cross-sectional diagram of a terminal connector 56A, 56B and a busbar assembly 50 is shown in accordance with one or more exemplary embodiments. Referring to FIG. 4, a schematic cross-sectional diagram of the terminal connector 56A, 56B and the busbar assembly 50 is shown in accordance with one or more exemplary embodiments.

The first distal end 54A of the busbar 52 includes a first slot 66A and a second slot 70A. The second distal end 54B of the busbar 52 (illustrated) includes a third slot 66B and a fourth slot 70B. The slots 66A, 66B, 70A, 70B extend through the busbar 52 from a first (lower) side 74 to a second (upper) side 76 of the busbar 52.

The first/third slots 66A, 66B are disposed longitudinally and centrally along the busbar 52. The first/third slots 66A, 66B are closer to the distal ends 54A, 54B of the busbar 52 than the second/fourth slots 70A, 70B. The first/third slots 66A, 66B are larger than the second/fourth slots 70A, 70B.

The second/fourth slots 70A, 70B are disposed longitudinally and centrally along the busbar 52. The second/fourth slots 70A, 70B are disposed at the distal ends 54A, 54B of the busbar 52. The slots 66A and 70A are sized to permit the first terminal connector 56A to slide back and forth a limited distance along the x-axis 62. The slots 66B and 70B are sized to permit the second terminal connector 56B to slide back and forth a limited distance along the x-axis 62. The sliding allows an overall length of the busbar assembly 50 to vary to accommodate mechanical tolerances when installed in the vehicle 10.

A first (lower) terminal cap 80A is disposed along the first side 74 of the corresponding distal end 54A, 54B of the busbar 52. The first terminal cap 80A may be disposed about a portion of the protective outer coating 72. The first terminal cap 80A may be a variation of, or the same as the first terminal cap 80 shown in FIG. 2.

The first cap cylindrical wall 112A of the first terminal cap 80A defines the first cap cylindrical bore 114. The first cap cylindrical bore 114 is aligned with the first/third slots 66A, 66B. The first terminal cap 80A may also define a second cap cylindrical bore 116. The second cap cylindrical bore 116 is aligned with the second/fourth slots 70A, 70B. In various embodiments, the first cap cylindrical wall 112A is fabricated of an electrically nonconductive material.

A second (upper) terminal cap 78A is disposed along the second side 76 of the corresponding distal end 54A, 54B of the busbar 52. The second terminal cap 78A may be disposed about a portion of the protective outer coating 72. The second terminal cap 78A is configured to snap into place with the first terminal cap 80A using the features 82, 84. The second terminal cap 78A may be a variation of, or the same as the second terminal cap 78 shown in FIG. 2.

A pocket 100 generally protruding vertically up in the second terminal cap 78A away from the busbar 52. The pocket 100 may be aligned with the first/third slots 66A, 66B and the second/fourth slots 70A, 70B. An opening (or hole) 102 is provided at a central-top end of the second terminal cap 78A. The opening 102 may be sized to be finger proof. The blind-hole nut 94A may be accessible through the opening 102. Threads (or threaded feature) 104 external to the pocket 100 are configured to accept and engage cap threads 160 of a cap 158A. The cap 158A may be the same as, or a variation of the cap 158 (FIG. 2). One or more retaining clips 106 are disposed inside the pocket 100. The retaining clips 106 are configured to retain the blind-hole nut 94A proximate (or near) the opening 102 prior to installation, and permits the blind-hole nut 94A to be moved away from the opening 102 and engage a threaded stud.

The pick and place feature 150 may be implemented as a cross-shaped protrusion extending away from the second terminal cap 78A. The pick and place feature 150 includes an alignment post 108 extending through the second/fourth slot 70A, 70B within the busbar 52. The alignment post 108 aids in alignment of the second terminal cap 78A and the first terminal cap 80A as the second terminal cap 78A and the first terminal cap 80A are assembled, and provides structural rigidity of the terminal connector 56A, 56B after being assembled.

The cap 158A is configured to thread onto and off of the threads 104. The cap 158A may be fabricated as a hexagonal extrusion with a flanged edge on an open bottom) end. The cap 158A generally includes a cylindrical internal pocket extending from the flanged edge upward and ending shy of protruding through a top end. The cap threads 160 are formed in the internal pocket walls. While installed on the threads 104, the cap 158A covers the opening 102 and thus provides a further barrier for unintentional contact with high voltages. In various embodiments, the cap 158A may be formed of a flameproof material that generally expands while heated. Other materials may be implemented to meet the design criteria of a particular application.

The blind-hole nut 94A generally extends through the first or third slot 66A, 66B within the busbar 52 and into the first cap cylindrical bore 114 created by the first cap cylindrical wall 112A. A flange 96 at an upper end 98 of the blind-hole nut 94A is sized to engage the retaining clips 106 while in an uninstalled configuration, and engage the busbar 52 while in an installed configuration. An electrically nonconductive tip 99 is pressed/over-molded/snaped onto the distal end of the blind-hole nut 94A opposite the flange 96. The electrically nonconductive tip 99 of the blind-hole nut 94A and the first cap cylindrical wall 112A are sized, arranged and/or spaced to be finger proof.

An external terminal 120A may be fabricated to mate with the busbar 52. The external terminal 120A generally includes a socket 122, a first terminal barrel 124A, a terminal busbar 126, and a threaded stud 128A. The socket 122 has a first socket cylindrical wall 130 that defines a first socket cylindrical bore 132. The socket 122 may be mechanically coupled between devices 60 and/or battery modules 61.

The first socket cylindrical wall 130 is fabricated from an electrically nonconductive material. The first socket cylindrical wall 130 and the first socket cylindrical bore 132 are sized to receive the first cap cylindrical wall 112A. The first terminal barrel 124A is disposed in the first socket cylindrical bore 132 and positioned to electrically engage the busbar 52 while the busbar 52 is installed on the external terminal 120A. The terminal busbar 126 is disposed in the socket 122, is electrically connected to the first terminal barrel 124A, and is configured to be coupled to other electrical equipment, such as a device 60 or a battery module 61. The threaded stud 128A is disposed in a center of the first socket cylindrical bore 132 and is electrically connected to the terminal busbar 126. The threaded stud 128A is align-able with and operational to engage the blind-hole nut 94A through the first/third slot 66A, 66B of the busbar 52. In various embodiments, the threaded stud 128A may be an over-molded stud. Electrical current 140 may flow in one or both directions between the busbar 52 and the terminal busbar 126.

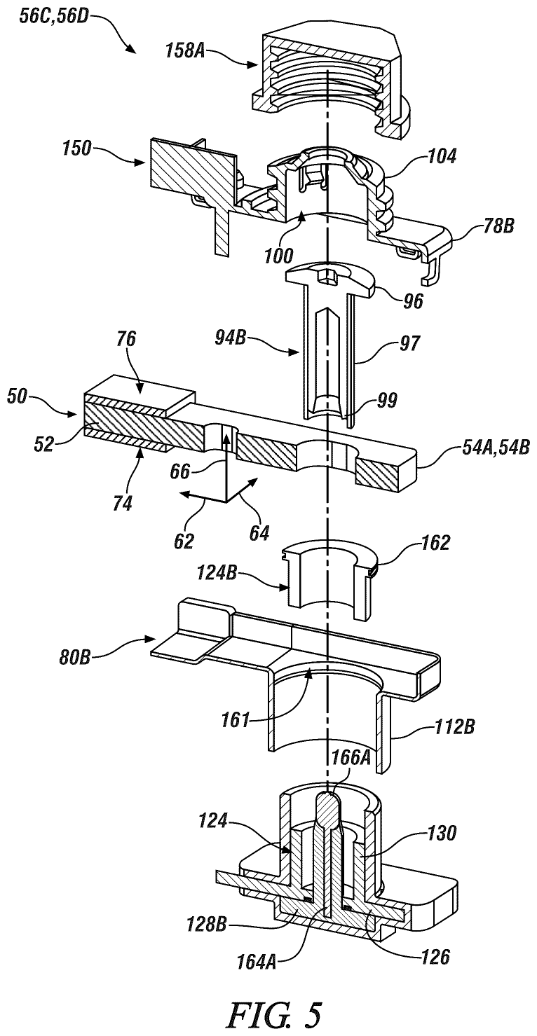

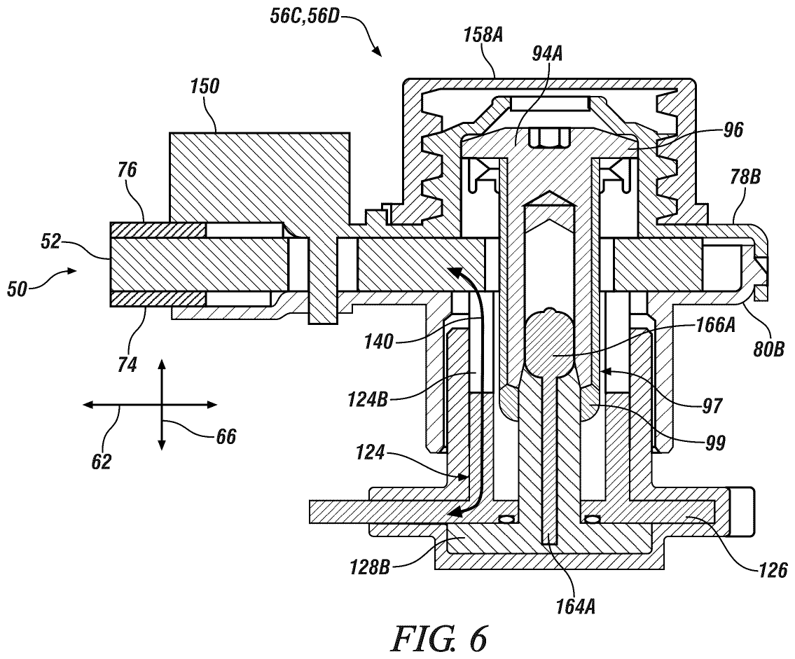

Referring to FIG. 5, a schematic exploded cross-sectional diagram of a terminal connector 56C, 56D and a busbar assembly 50 is shown in accordance with one or more exemplary embodiments. Referring to FIG. 6, a schematic cross-sectional diagram of the terminal connector 56C, 56D and the busbar assembly 50 is shown in accordance with one or more exemplary embodiments. The first terminal connector 56C may be a variation of the first terminal connector 56A. The second terminal connector 56D may be a variation of the second terminal connector 56B.

On the first side 74 of the busbar assembly 50, the terminal connector 56C, 56D includes a first (or lower) terminal cap 80B, a first cap cylindrical wall 112B, the first terminal barrel 124A, the terminal busbar 126, and a threaded stud 128B. The first terminal cap 80B may be the same as, or a variation of the first terminal cap 80A (FIG. 3) and/or 80 (FIG. 2). The terminal connector 56C, 56D may further include a second terminal barrel 124B disposed between the first terminal barrel 124A and the busbar 52. In various embodiments, the second terminal barrel 124B may be loose. In other embodiments, the second terminal barrel 124B may be secured (e.g., welded) to the busbar 52.

The first cap cylindrical wall 112B is a variation of the first cap cylindrical wall 112A. The first cap cylindrical wall 112B may include a recess 161 on an end of the wall furthest from the busbar 52.

The second terminal barrel 124B may be a variation of the first terminal barrel 124A. The second terminal barrel 124B generally includes a lip 162 sized to seat in the recess 161 of the first cap cylindrical wall 112B. The second terminal barrel 124B is disposed between the first terminal barrel 124A and the busbar 52 and is positioned to electrically connect the first terminal barrel 124A to the busbar 52.

The threaded stud 128B may be a variation of the threaded stud 128A. The threaded stud 128B has a central bore that is aligned normal to the terminal busbar 126. A post 164A is disposed coaxially within the central bore of the threaded stud 128B. The post 164A has a post tip 166A that extends beyond the threaded stud 128B away from the terminal busbar 126. The post 164A, the post tip 166A, and the first socket cylindrical wall 130 are fabricated from electrically nonconductive material. The post tip 166A and the first socket cylindrical wall 130 are sized, arranged and/or spaced to be finger proof.

On the second side 76 of the busbar assembly 50, the terminal connector 56C, 56D includes a second terminal cap 78B, the blind-hole nut 94A, the first pick and place feature 150 and the cap 158A. The second terminal cap 78B may be the same as, or a variation of the second terminal cap 78A (FIG. 3) and/or 78 (FIG. 2). In various embodiments, the blind-hole nut 94A may be covered by an insulator 97 on an exterior of the blind-hole nut 94A. The insulator 97 may extend from the electrically nonconductive tip 99 to the flange 96.

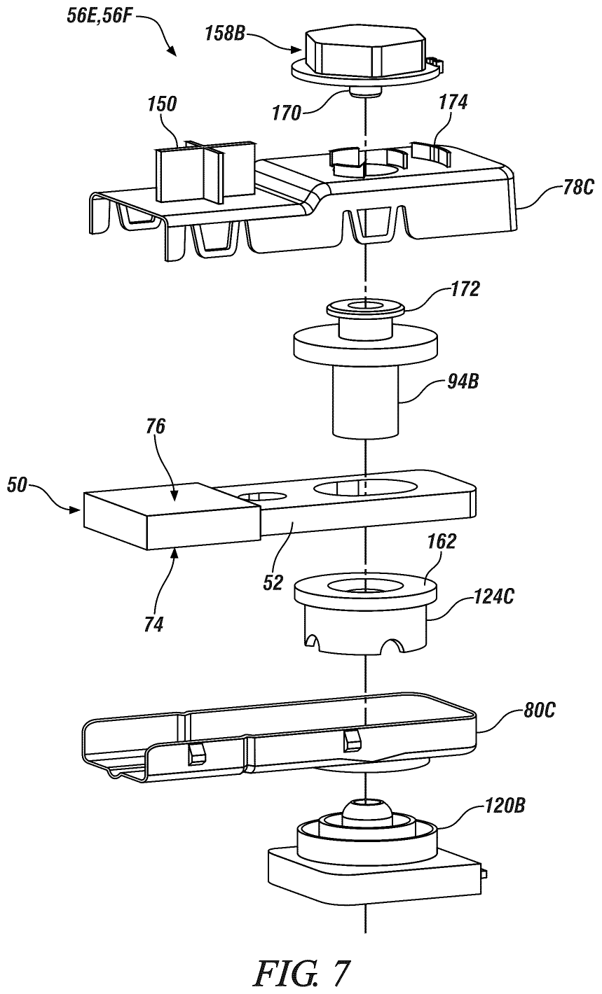

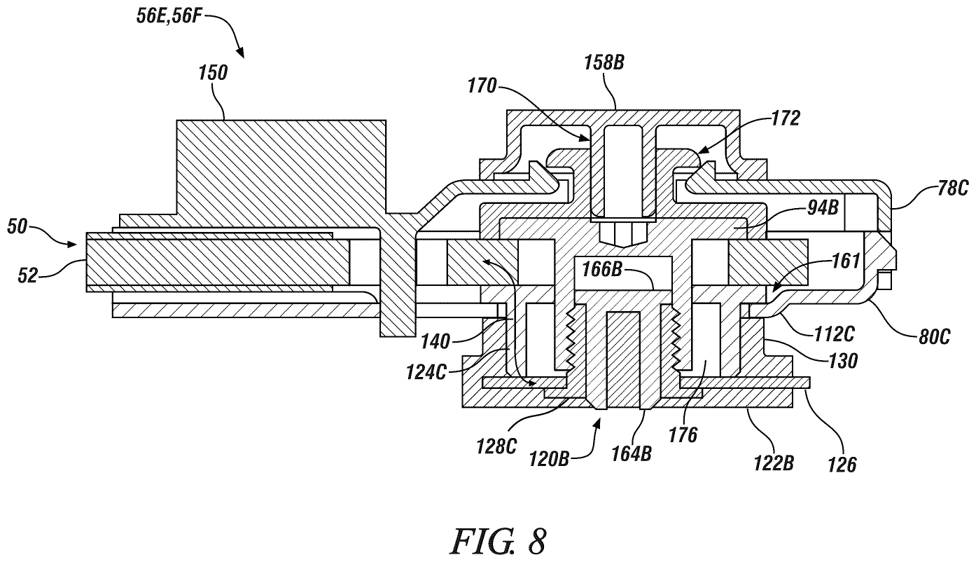

Referring to FIG. 7, a schematic exploded cross-sectional diagram of a terminal connector 56E, 56F and a busbar assembly 50 is shown in accordance with one or more exemplary embodiments. Referring to FIG. 8, a schematic cross-sectional diagram of the terminal connector 56E, 56F and the busbar assembly 50 is shown in accordance with one or more exemplary embodiments. The first terminal connector 56E may be a variation of the first terminal connector 56A and/or 56C. The second terminal connector 56F may be a variation of the second terminal connector 56B and/or 56D.

On the first side 74 of the busbar assembly 50, the terminal connector 56E, 56F includes a first (or lower) terminal cap 80C, a first cap cylindrical wall 112C, a first terminal barrel 124C, the terminal busbar 126, a threaded stud 128C, a post 164B with a post tip 166B. The first terminal cap 80C may be a variation of the first terminal cap 80B (FIG. 5), 80A (FIG. 3) and/or 80 (FIG. 2).

On the second side 76 of the busbar assembly 50, the terminal connector 56E, 56F includes a second terminal cap 78C, a blind-hole nut 94B, the first pick and place feature 150 and a cap 158B. The second terminal cap 78C may be a variation of the second terminal cap 78B (FIG. 5), 78A (FIG. 3) and/or 78 (FIG. 2).

The terminal connectors 56E, 56F may mate with an external terminal 120B. The external terminal 120B may be a variation of the external terminal 120A (FIG. 3). The external terminal 120B generally includes a socket 122B, the terminal busbar 126, the first socket cylindrical wall 130, and a second socket cylinder wall 176. The post tip 166B, the first socket cylindrical wall 130, and a second socket cylinder wall 176 are fabricated from electrically nonconductive materials. The post tip 166B, the first socket cylindrical wall 130, and a second socket cylinder wall 176 are sized, arranged and/or spaced to finger proof access to the high voltage on the terminal busbar 126 and the threaded stud 128C.

The cap 158B may be a variation of the cap 158A (FIG. 5). The cap 158B generally includes a centrally-located cap thread 170. The cap thread 170 may be attached to a roof of the cap 158B and oriented normal to the busbar 52. The blind-hole nut 94B may be a variation of the blind-hole nut 94A (FIG. 5). The blind-hole nut 94B includes a nut over molded cap 172. The nut over molded cap 172 may be threaded to engage the cap threads 170 of the cap 158B. The nut over molded cap 172 may be fabricated on an electrical nonconductive material. The nut over molded cap 172 may be sized and arranged to finger proof access to the high voltage via the second terminal cap 78C. To further secure the cap 158B to the second terminal cap 78C, multiple flanges 174 on the second terminal cap 78C may be positioned to engage an outer edge of the cap 158B.

The terminal barrel 124C may be a variation of the second terminal barrel 124B (FIG. 5). The terminal barrel 124C may electrically connect the busbar 52 directly to the terminal busbar 126. The terminal barrel 124C may include the lip 162. The lip 162 may be seated in the recess 161 of the first cap cylindrical wall 112C to hold the terminal barrel 124C to the first terminal cap 80C.

The first terminal cap 80C may have a short first cap cylindrical wall 112C (FIG. 8) compared with the first cap cylindrical wall 112A (FIG. 3) and the first cap cylindrical wall 112B (FIG. 5). The short first cap cylindrical wall 112C aids in achieving a low profile for the terminal connector 56E, 56F.

The second terminal cap 78C may lack the threads 104 around the pocket 100 (both 100 and 104 are removed). Instead of the cap 158A engaging the threads 104 on the second terminal cap 78B (FIG. 5), the cap 158B engages the threads of the nut over molded cap 172. The absence of the pocket 100 and the threads 104 may aid in reducing the profile of the terminal connector 56E, 56F.

The threaded stud 128B may be the same as, or a variation of the threaded stud 128A (FIG. 5). The post 164B in the threaded stud 128B may be the same as, or a variation of the post 164A (FIG. 5). The post tip 166B on the post 164B may be the same as, or a variation of the post tip 166A (FIG. 5).

Embodiments of the electrical connectors may incorporate a custom blind-hole nut on the busbar side with a finger proof cap. A design of the electrical connectors may over mold the blind-hole nut to reduce joint height. Various embodiments may incorporate an internally over molded bolt on the opposite corresponding side of the terminal making the opposite side fully finger proof in the installed and uninstalled configuration. Some embodiments incorporate snap retaining features into the upper cap to hold the over molded blind-hole nut while still allowing rotation and installation. The electrical connectors may incorporate internal threads into the finger-proof over molding that allows reception of the cap over the opening in the second terminal cap. Some designs may incorporate over molding on the first (bottom) terminal cap that creates error proof, anti-rotation, and finger proof functionality. Furthermore, embodiments eliminate fasteners pointed towards internal modules/cells.

In various embodiments, the design allows the terminals to be finger proofed on an underside of the busbar in an installed condition and an un-installed condition. The designs allow the corresponding terminal interfaces to be finger proof in the installed condition and un-installed condition. A flameproof cap may be incorporated. In some embodiments, a z-height of the electrical connectors may be reduced and/or minimized.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. An electrical terminal comprising:
a first terminal cap couplable to a first side of a busbar, wherein the first terminal cap includes a first cap cylindrical wall that defines a first cap cylindrical bore;
a second terminal cap couplable to a second side of the busbar opposite the first side and connected to the first terminal cap, wherein the second terminal cap defines an opening that is sized to be finger proof;
a blind-hole nut disposed in the second terminal cap, wherein (i) the blind-hole nut has a flange and an electrically nonconductive tip opposite the flange and (ii) the electrically nonconductive tip and the first cap cylindrical wall are arranged to be finger proof;
a socket couplable to a device, wherein (i) the socket includes a first socket cylindrical wall that defines a first socket cylindrical bore, and (ii) the first socket cylindrical wall is sized to receive the first cap cylindrical wall;
a first terminal barrel dispose in the first socket cylindrical bore and positioned to electrically engage the busbar; and
a threaded stud disposed in the first socket cylindrical bore, wherein the threaded stud is operational to engage the blind-hole nut.

2. The electrical terminal according to claim 1, further comprising:
a cap threaded on the second terminal cap and covers the opening.

3. The electrical terminal according to claim 1, further comprising:
one or more retaining clips disposed in the second terminal cap, wherein the one or more retaining clips are operational to engage the flange of the blind-hole nut to alternately (i) retain the blind-hole nut proximate the opening and (ii) permit the blind-hole nut to move away from the opening and engage the threaded stud.

4. The electrical terminal according to claim 1, further comprising:
an insulator on an exterior of the blind-hole nut, wherein the insulator extends from the electrically nonconductive tip to the flange.

5. The electrical terminal according to claim 1, further comprising:
a second terminal barrel (i) disposed between the first terminal barrel and the busbar and (ii) positioned to electrically connect the first terminal barrel to the busbar.

6. The electrical terminal according to claim 5, further comprising:
a post disposed coaxially within the threaded stud, wherein (i) the post has a post tip that extends beyond the threaded stud and (ii) the post tip and the first socket cylindrical wall are arranged to be finger proof.

7. The electrical terminal according to claim 5, wherein the second terminal barrel is physically attached to the busbar.

8. The electrical terminal according to claim 1, wherein:
the first terminal barrel includes a rim; and
the first terminal cap defines a recess sized to receive the rim of the first terminal barrel.

9. The electrical terminal according to claim 1, further including:
a second socket cylindrical wall coaxially disposed inside the first socket cylindrical wall, wherein the first terminal barrel is partially disposed between the first socket cylindrical wall and the second socket cylindrical wall.

10. The electrical terminal according to claim 9 further comprising:
a post disposed coaxially within the threaded stud, wherein (i) the post has a post tip that extends beyond the threaded stud and (ii) the post tip, the first socket cylindrical wall and the second socket cylindrical wall are arranged to be finger proof.

11. A method for manufacturing an electrical terminal comprising:
fabricating a first terminal cap couplable to a first side of a busbar, wherein the first terminal cap includes a first cap cylindrical wall that defines a first cap cylindrical bore;
fabricating a second terminal cap couplable to a second side of the busbar opposite the first side, wherein the second terminal cap defines an opening that is sized to be finger proof;
connecting the first terminal cap to the second terminal cap;
disposing a blind-hole nut in the second terminal cap, wherein (i) the blind-hole nut has a flange and an electrically nonconductive tip opposite the flange and (ii) the electrically nonconductive tip and the first cap cylindrical wall are arranged to be finger proof;
fabricating a socket couplable to a device, wherein (i) the socket includes a first socket cylindrical wall that defines a first socket cylindrical bore, and (ii) the first socket cylindrical wall is sized to receive the first cap cylindrical wall;
disposing a first terminal barrel in the first socket cylindrical bore and positioned to electrically engage the busbar; and
disposing a threaded stud in the first socket cylindrical bore, wherein the threaded stud is operational to engage the blind-hole nut.

12. The method according to claim 11, further comprising:
threading a cap on the second terminal cap to cover the opening.

13. The method according to claim 11, further comprising:
forming one or more retaining clips in the second terminal cap, wherein the one or more retaining clips are operational to engage the flange of the blind-hole nut to alternately (i) retain the blind-hole nut proximate the opening and (ii) permit the blind-hole nut to move away from the opening and engage the threaded stud.

14. The method according to claim 11, further comprising:
forming an insulator on an exterior of the blind-hole nut, wherein the insulator extends from the electrically nonconductive tip to the flange.

15. The method according to claim 11, further comprising:
forming a second terminal barrel (i) between the first terminal barrel and the busbar and (ii) positioned to electrically connect the first terminal barrel to the busbar.

16. The method according to claim 15, further comprising:
forming a post coaxially within the threaded stud, wherein (i) the post has a post tip that extends beyond the threaded stud and (ii) the post tip and the first socket cylindrical wall are arranged to be finger proof.

17. The method according to claim 15, further comprising:
attaching the second terminal barrel physically to the busbar.

18. The method according to claim 11, wherein:
the first terminal barrel includes a rim; and
the first terminal cap defines a recess sized to receive the rim of the first terminal barrel.

19. The method according to claim 11, further including:
forming a second socket cylindrical wall coaxially inside the first socket cylindrical wall, wherein the first terminal barrel is partially disposed between the first socket cylindrical wall and the second socket cylindrical wall; and
forming a post coaxially within the threaded stud, wherein (i) the post has a post tip that extends beyond the threaded stud and (ii) the post tip, the first socket cylindrical wall and the second socket cylindrical wall are arranged to be finger proof.

20. A vehicle comprising:
a device;
a busbar;
a first terminal cap coupled to a first side of the busbar, wherein the first terminal cap includes a first cap cylindrical wall that defines a first cap cylindrical bore;
a second terminal cap coupled to a second side of the busbar opposite the first side and connected to the first terminal cap, wherein the second terminal cap defines an opening that is sized to be finger proof;
a blind-hole nut disposed in the second terminal cap, wherein (i) the blind-hole nut has a flange and an electrically nonconductive tip opposite the flange and (ii) the electrically nonconductive tip and the first cap cylindrical wall are arranged to be finger proof;
a socket coupled to the device, wherein (i) the socket includes a first socket cylindrical wall that defines a first socket cylindrical bore, and (ii) the first socket cylindrical wall is sized to receive the first cap cylindrical wall;
a first terminal barrel dispose in the first socket cylindrical bore and positioned to electrically engage the busbar; and
a threaded stud disposed in the first socket cylindrical bore, wherein the threaded stud is operational to engage the blind-hole nut.
